(19) United States
(12) Patent Application Publication
(10) Pub. No.: US 2004/0204047 A1
(43) Pub. Date: Oct. 14, 2004

(54) Automobile computing

(76) Inventor: Jeffrey Wayne Steed, Little Rock, AR (US)

Correspondence Address: Jeffrey W. Steed, 12601 Valleywood Drive, Little Rock, AR, 72211, US

(21) Appl. No.: 10/189,684

(22) Filed: Jul. 8, 2002

(51) Int. Cl. H04M 1/00

(52) U.S. Cl. 455/556.1; 455/412.1

(57) ABSTRACT

The on-board, automobile computer (MC) for the end-user includes Internet and email communication through cellular technology, along with other features. Services include MCRadio, which provides radio station listening options that are available via the Internet. Also, with the available services, email capabilities are provided (MCMail). Other options include MCInfo, which provides user-requested information via the Internet that is delivered to the user with voice capabilities. MCShop provides shopping capabilities through the automobile computer. All options are provided with voice-capabilities and/or manual operation. All of the MC options mentioned previously are available through a host computer via cellular technology, which retrieves the user-requested information and the information is sent back to the user.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF INVENTION

Computing technology, cellular technology.

### BRIEF SUMMARY OF THE INVENTION

The on-board, automobile computer (MC) for the end-user includes Internet and email communication through cellular technology, along with other features. Services include MCRadio, which provides radio station listening options that are available via the Internet. Also, with this product and available services, email capabilities are provided (MCMail). Other options include MCInfo, which provides user-requested information via the Internet that is delivered to the user via voice capabilities. MCShop provides shopping capabilities through the automobile computer. All options are provided with voice-capabilities and/or manual operation.

All of the “MC” options mentioned above are available through a host computer that connects the users to the available features. Specifically, through cellular communication, the user's MC system connects to the host computer. The host computer retrieves the requested information and sends it back to the MC system.

### BRIEF DESCRIPTION OF THE SEVERAL VIEWS OF THE DRAWING

Not Applicable.

### DETAILED DESCRIPTION OF THE INVENTION

The on-board, automobile computer (MC) for the end-user includes Internet and E-mail communication through cellular technology, along with other features. Options/features/services/include:

1. MCRadio: Radio listening options that are available via the Internet. For example, with a preset option, a user can automatically start receiving audio via a website that hosts radio, audio-streaming. The audio can be music-oriented or talk-oriented.

2. MCMail: With this option, an individual's email can be delivered in time-determined intervals and read off to the user with the capability to respond. The response is selected by the user for a voice-recording format or a voice-to-text translated message. The originally received email is forwarded as “read” back to the user's email address for logging unless otherwise directed for deletion by the user. These forwarded “read” emails are looped back to the designated email address instead of being re-reported to the user after each interval email download process. With this option, emails can also be created by voice-to-text recognition and sent.

3. MCInfo: MCInfo provides user-requested information via the Internet that is available with voice capabilities.

4. MCShop provides shopping capabilities through the automobile computer.

All options/features/services are available with voice capabilities and/or manual operation. All of the MC options/features/services mentioned above are available through a host computer that connects the users to the available features.

Specifically, through cellular communication, the user's MC system connects to the host computer with an identification number that is approved for logon. The user gives the requested information to the MC system by voice or manual operation. The host computer receives the user request, retrieves the requested information and sends it back to the MC system. This requested information may include live web feed, such as an audio stream for the MCRadio service.

Before use of the service, the user setups up his or her required information on the host website via a computer other than the MC unit. Also, information related to individual preferences are setup on the host website. Information can be changed as desired by logging on to the host website.

What I claim as my invention is:

1. The communication process via cellular technology as described within the “Detailed Description of the Invention”, which involves the automobile computing unit (MC), the host unit, and Internet/email connections.

2. The available automobile computing services/options/features mentioned in the “Detailed Description of the Invention”, which are named accordingly MCRadio, MCMail, MCInfo, and MCShop.
